(19) United States
(12) Patent Application Publication
(10) Pub. No.: US 2005/0033637 A1
(43) Pub. Date: Feb. 10, 2005

(54) Bill payment incentives system

(76) Inventor: Kenneth Lee Underwood, Ponte Vedra Beach, FL (US)

Correspondence Address: KEVIN A. BUFORD;HOLLAND & KNIGHT LLP, 1600 TYSONS BOULEVARD, SUITE 700, MCLEAN, VA, 22102, US

(21) Appl. No.: 10/636,302

(22) Filed: Aug. 6, 2003

(51) Int. Cl. G06F 17/60

(52) U.S. Cl. 705/14; 705/39; 705/40

(57) ABSTRACT

A bill payment system, in a presently preferred embodiment, includes a system having an agent for initiating a request to make a payment to a payee from a funds account, verifying there are sufficient funds in the account to make the payment, transferring the selected amount from the funds account to a charge card account, paying the payee from the charge card account, and applying an incentive award for the charge amount. The agent will also open and configure a payee profile for the funds account if there is a new payee, and prompt the customer for a reduced payment if the funds account does not have sufficient funds to make the requested payment. The agent additionally prompts the customer for new services based on predetermined parameters. The agent can be a human agent, an intelligent program, or combination of the two working together. Thus, bill payment can be performed by a single rewarding telephone call to an agent who assists the customer through the process, or by an online transaction, at the customer's preference.

### FIELD OF THE INVENTION

The invention in general relates to the field of financial services, and more particularly to bill payment systems.

### BACKGROUND

No one likes to pay bills. For most people it is a tedious, undesirable chore that they regularly procrastinate on performing. Part of what makes paying bills so tedious is the combination of repetitious, time-consuming activities like writing out checks, combined with the necessary tasks of periodically balancing accounts, or at least determining that there are still sufficient account balances for the bills being paid. These chores may take over 30 minutes to an hour each week to perform, and for the more financially-challenged may even be neglected to the point that account reconciliation is all but hopelessly beyond their skills or patience.

Two recent solutions that have been offered to address aspects of this long-standing problem have been software accounting packages, and more accessible automatic charging to credit card accounts. In the case of software accounting packages, programs like Quicken or Microsoft Money have made significant strides in making accounting tools more accessible to a broader range of users. However, these still take time and a degree of computer and financial so phistication to set up properly which are beyond many people. Also, to actually pay bills one must either have special checks that can be run through a local printer, or a connection to an on-line payment service, typically at an extra charge. For those that do not have the patience, aptitude or access to electronic banking, more and more companies are encouraging payment by direct account debits or credit card charges. While these are more convenient for consumers than the ritual of writing checks, it does take special authorization forms to set up each payee transaction. Since these authorizations are inconvenient to change, they are typically either for fixed amounts or for the full amount billed by the payee. Consumers thus loses much of their control over the timing and amounts of payment. In some cases there are still transaction charges, and any delay in payment incurs significant financial service charges.

Thus, there remains a need for an easier, more accessible way to pay bills. Just such a solution to these problems and others, together with incentives fore regular use, is made possible by my invention.

### SUMMARY

An illustrative summary of the invention, with particular reference to the detailed embodiment described below, includes a bill payment system having an agent for initiating a request to make a payment to a payee from an funds account, verifying there are sufficient funds in the account to make the payment, transferring the selected amount from the funds account to a payment card account, paying the payee from the payment card account, and applying an incentive, award, for the charge amount. The agent will also open and configure a payee profile for the funds account if this is a new payee, and prompt the customer for a reduced payment if the funds account does not have sufficient funds to make the requested payment. Thee agent additionally prompts the customer for new services base on predetermined parameters. The agent can be a human agent, an intelligent program, or combination of the two working together. Thus, bill payment can be performed by a single telephone call to an agent who assists the customer through the process, or by an online transaction, at the customer's preference.

### THE FIGURES

My invention may be more, readily appreciated from the following detailed description, When read in conjunction with the accompanying drawings, in which:

FIG. 1 is a general block diagram illustrating a bill payment system according to a first embodiment of thee invention;

FIG. 2 is a flow chart illustrating a bill payment process in the system of FIG. 1.

### DETAILED DESCRIPTION OF AN EMBODIMENT OF THE INVENTION

A presently preferred embodiment according to my invention includes a bill payment system that accommodates both telephony and online processing, at the customer's convenience. An agent of the financial institution receives the payment request and prompts the customer for payment details. An incentive award is applied to all payments made. The agent will also open and configure a payee profile for the funds account if this is a new payee, and prompt the customer for a reduced payment if the account does not have sufficient funds to make the requested payment. The agent additionally prompts the customer for new services. This unique approach advantageously allows for a much more convenient and rewarding payment process, making for enhanced customer good will, while also allowing the financial institution a convenient way to notify the customer of new services.

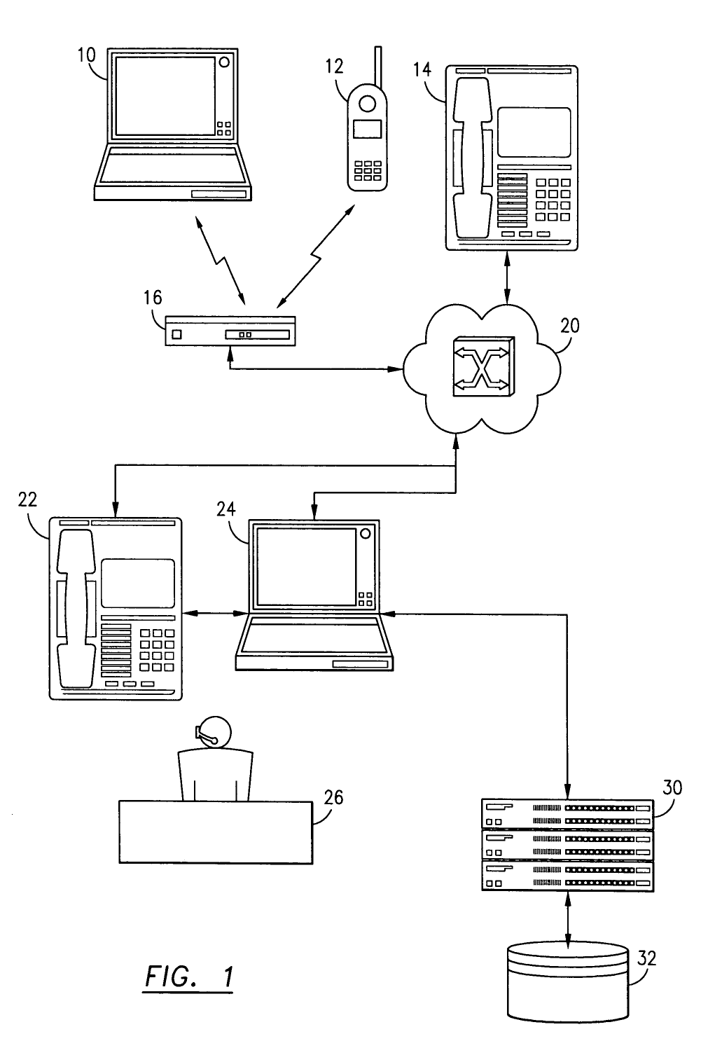

This preferred embodiment of the invention may be better understood by first considering the illustrative system diagram, shown in FIG. 1. Because the system is designed for customer convenience, it preferably allows for payment by a variety of access systems. A preferred system includes a telephony access, with voice prompts to the customer walking her or him through each stage of the transaction. The customer can conveniently call by any telephony device, including either a traditional wired phone 14 or cellular or other wireless voice device 12. Additional instruments for data entry and prompts may also be used, such as the illustrated computer 10 connected to the financial institution via access point 16 and the internet/PSTN (public switched telephone network) 20, or any other processor- and network-enabled data entry device such as PDAs (personal digital assistants) and internet kiosks.

The customer is connected to an agent 26 of the financial institution via a voice device such as a telephone 22, or a data device such as a computer 24. The agent's data device (e.g., computer 24) is networked so as to access an appropriate one or more data processing devices such as a mainframe computer or the illustrated server 30 and data stores such as the illustrated customer/account database 32. The agent can be either a human agent or an intelligent program, but preferably includes both to allow for the most convenient payment mechanism for the institution's different customers. The financial institution is preferably an institution that offers funds accounts (e.g., savings, checking, and/or investment accounts) and payment card services, but it can also include a company capable of processing the desired customer transaction with other financial services entities holding a customer's funds accounts and/or payment account. Illustrative current examples of payment accounts include (a) charge card accounts (e.g., one that requires a card holder to pay his or her full balance upon receipt of a billing statement from the issuer of the card within an agreed period, such as for an American Express card); (b) credit card accounts (e.g., one that permits cardholders to pay only a portion of the balance due on the account after receipt of a billing statement, such as for a MasterCard of Visa account); (c) general purpose card accounts (e.g., one that includes credit and charge cards, but excludes in-store (proprietary) credit cards and debit cards); (d) proprietary card accounts (e.g., one that includes store-owned accounts like Sears, Macy's, etc.); and (e) debit card accounts (e.g., any variety of bank or other service provider accounts allowing “online” or ATM (pin required) and “offline” (signature and/or pin required) withdrawal of funds from an account having funds or line of credit allowing withdrawal of funds).

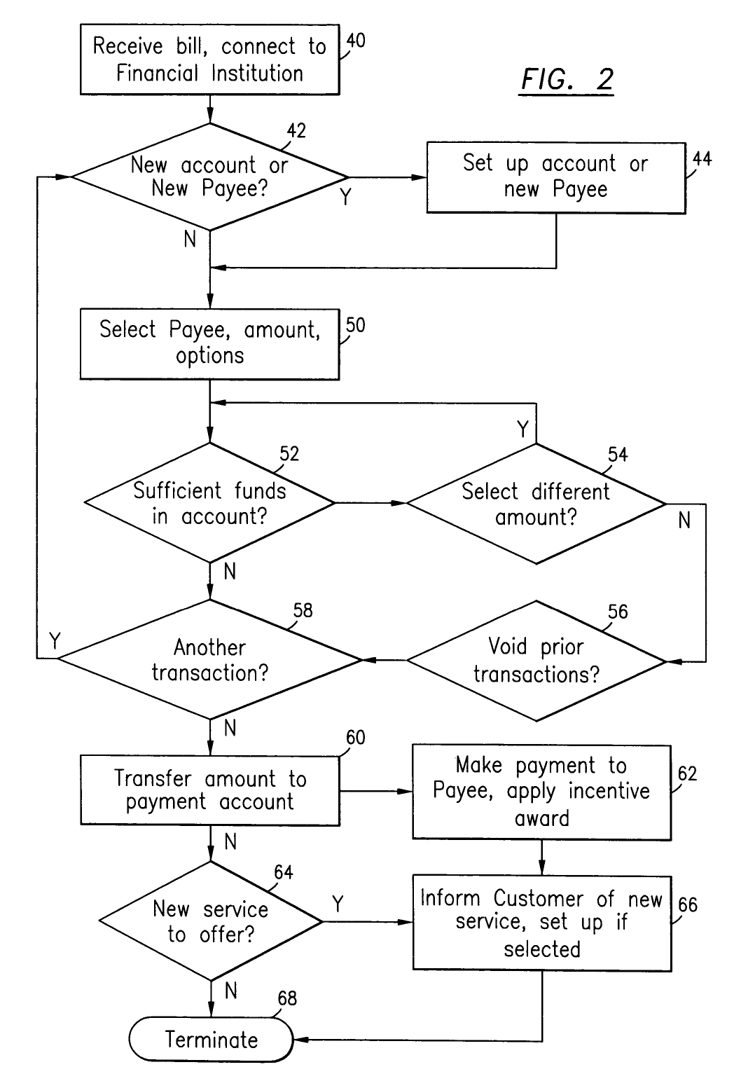

This system may be better understood by reference to FIG. 2, which illustrates a process for making bill payment according to a presently preferred embodiment of the invention. When the customer receives an invoice or payment request, he or she connects to their financial institution by one of the available means (step 40). If connecting by voice/telephony, the customer will be connected to a human agent, a voice-enabled program agent, or some combination of the two. If connecting via a data device, the customer will typically connect to a program agent, but may have the option to connect (e.g., by a dialog window, instant message pane, or even a direct dial number) to a human agent. On first connecting, the customer will be prompted for appropriate authorization (e.g., authentication by PIN or unique identifier such as social security number or date of birth) to access account services. If the transaction involves setting up a new account or changing an account profile (step 42), the agent will walk the customer through the necessary steps to set up his or her account for the new bill payment services (step 44). This can be as simple as a set of prompts identifying the fund and payment accounts to be used for a first time set up, and Payee name, account and address information, but may require additional information and authentication. For example, the set up may require changes to a customer or account profile, activation of an incentive awards profile or account coupled to the payment card account, configuration for use with other institution accounts (such as another financial services company credit card account) or even a funds transfer to provide sufficient funds for payment using the customer's funds account. Different financial institutions will have different requirements for account set up, and one skilled in the art will readily understand how to set up appropriate processes with prompts to conveniently assist the customer through the account set up steps.

For accounts that have already been set up, the customer will be prompted for necessary bill payment information. From the customer's perspective this can be as simple as dialing a bill payment number, providing a bill payment identifier (e.g., funds account number) and appropriate authentication, and providing the Payee name and amount to be paid (step 50). Thus, by a series of simple voice prompts, a customer can provide the agent with all the necessary information to pay her or his bills in a matter of minutes. Additional or optional features can also be added, such as prompting the customer for a payment date if payment is not to be processed immediately. The agent will input the information received, and request a funds transfer from the funds account. The appropriate funds account is either selected by the customer as part of their initial prompts, of if a different bill payment account number is used the funds account indicated in a saved profile will be used, based on information entered during account set up.

If there are insufficient funds in the account for the selected payment, the customer is prompted to select a different payment amount (steps 52, 54). The customer may optionally be allowed to step back through other transactions just entered, voiding all or just individual entries, in order to find necessary funds to pay the amounts desired for each payee, in view of the limited funds available (step 56).

The process above is repeated for as many transactions as the customer wants to process during the current session (step 58). Each transaction is processed, preferably after a customer confirmation and after all transactions have been entered (step 60). Alternatively, a skilled artisan will appreciate that the order of the steps may be modified based on design goals of the financial institution, including the immediate processing of each transaction as entered, with or without option to void (e.g., by agent assistance) after entry. Typical processing includes transferring the selected amounts from the funds account, along with payee information, to the payment account indicated in the customer/account profile (e.g., during set up). The indicated payees and amounts are then paid out of the payment account, with notification of payment to the payee as optionally desirable (steps 60, 62).

While the convenience and ease of paying bills by the above process may be sufficient motivation by itself for customers to want to use my invention, they may additionally encouraged to pay via the above system by incentive awards. Thus, in a preferred system each payment is credited with an appropriate incentive (step 62). This could include a predetermined ratio of bonus points to amounts paid. In lieu of bonus points, any appropriate award may be applied, including but not limited to credited dollars into the funds account, airline mileage points, and the like. If more than one form of incentive award is offered, the appropriate form can be selected during an account set up step. This incentive awards process is both advantageous to the customer, who receives a benefit for using the bill paymnent system, and the financial institution, which builds customer good will and repeat business, and other financial benefits.

Another advantageous feature is illustrated in steps 64-66, in which a customer may be offered new services during the bill payment session. This can happen at any point in the process, but may be best left for after all transactions have been entered. In the preferred system the customer is prompted based on a saved profile to choose whether she or he would like to hear about a new service now (or alternatively wait for news by means like mail). Rather than risk annoying the customer with too many offers, a profile of the customer is preferably built and stored, and only those new services matching the customer profile are offered. A skilled artisan will appreciate that a variety of programs and characteristics can be used for building customer profiles and determining what profiles should be matched to a particular service being offered (whether new or just new to the customer), and such can be readily implemented by a variety of means to facilitate the delivery of appropriate prompts to the customer. By offering this additional feature, the bill payment system becomes a significant point of contact between the financial institution and its customers, extending and enhancing the relationship for both.

Further, many customers will find that the above system provides them with yet another benefit in the ease of tracking all their accounts used in paying for goods and services. Rather than having to maintain and reconcile separate records, such as checks against checking account statements, or buy separate software packages and constantly enter all the data needed, the financial institution's systems are appropriately programmed to take care of all the necessary steps, and provide each customer with account statements showing accurate, detailed information of all activity, and (if multiple formats are offered) in the form desired by the customer.

Those skilled in the art will appreciate that while certain specific embodiments have been discussed above, such as the use of bank or credit union employees to assist customers in paying their bills, or direct online payment via program agents (whether by voice recognition or other data entry systems), other components and steps may be used with readily understood design trade-offs based upon specific customer, account, and payment configurations. Further, while the system has been described in connection with paying bills, it may also be used to effect any payment, whether in the form of an obligation like a bill or a voluntary payment like a charitable donation or a gift. While the foregoing constitutes certain present, preferred and alternative embodiments, of the invention, it is to be understood that the invention is not limited thereto, and that in light of the present disclosure various other embodiments should be apparent to persons skilled in the art. Thus, while the preferred embodiment is illustrated in connection with voice or data access to a funds account and payment and awards via a payment account, the invention may be used in connection with other types of customer account and financial service company configurations. Accordingly, those skilled in the art will recognize that changes can be made without departing from the scope of the invention as particularly pointed out and distinctly claimed in the appended claims, which should be construed to encompass all legal equivalents thereof.

1. A method for making financial payments by a user remote from an agent of a financial services company assisting in making the payments, comprising:
a. receiving payee information, including an amount to pay a payee, from the user;
b. transferring said amount from a funds account from which the user is authorized to withdraw to a payment card account, together with additional payee information;
c. paying the amount to the payee from the payment card account; and
d. applying an incentive award to the payment card account based upon the amount paid.

2. The method of claim 1, further comprising the step of verifying that the funds account has sufficient funds to cover payment of said amount prior to step b.

3. The method of claim 1, wherein the payment card account is one of a charge card account, credit card account, general purpose card account, proprietary card account and debit card account, the method further comprising the step of the agent prompting the user for the payee information after a payment session is initiated.

4. The method of claim 3, wherein the agent is one of a human agent, an automated program agent, or a combination of a human and automated program agent working together, the method further comprising the agent prompting the user with information about new service offerings during the payment session.

5. The method of claim 4, further comprising the agent prompting the user for account or payee set up information prior to step b.

6. The method of claim 1, further comprising prompting the user for further payee information, including a further amount to pay a further payee, and repeating steps a. through d. for payment of said further amount.

7. The method of claim 6, further comprising the step of verifying that the funds account has sufficient funds to cover payment of said further amount prior to a repeated step b., and if there are not sufficient funds, prompting the user to select one of the group of a (i) different amount for use as part of the further payee information, and (ii) canceling a prior payment transaction.

8. A financial payment system for making financial payments by a user remote from an agent of a financial services company assisting in making the payments, comprising:
an agent capable of receiving payee information, including an amount to pay a payee, from the remote user;
a financial services program operable to (i) receive the payee information from the agent, (ii) transfer said amount from a funds account from which the user is authorized to withdraw to a payment account, together with additional payee information, (iii) pay the amount to the payee from the payment account, and (iv) apply an incentive award to the payment account based upon the amount paid.

9. The system of claim 8, further comprising a user input device operable by a user for inputting the payee information in response to prompts by the agent.

10. The system of claim 8, wherein the agent is one of the group of a human agent, an intelligent program agent, and a combination of a human agent and an intelligent program agent operable to work with the human agent.

11. The system of claim 8, wherein the financial services program is further operable to verify that the funds account has sufficient funds to cover payment of said amount prior to transferring said amount.

12. The system of claim 8, wherein the payment account is one of a charge card account, credit card account, general purpose card account, proprietary card account and debit card account, and the financial services program is further operable to prompt the user via the agent for the payee information after a payment session is initiated.

13. The system of claim 12, wherein the financial services program is further operable to prompt the user via the agent with information about new service offerings during the payment session.

14. The system of claim 12, wherein the financial services program is further operable to prompt the user via the agent for account or payee set up information and, upon receiving the account or payee set up information, changing a stored user profile for use in connection with future,financial payments by the user.

15. The system of claim 12, wherein the financial services program is further operable to prompt the user via the agent for further payee information, including a further amount to pay a further payee, and paying said further amount.

16. The system of claim 15, wherein the financial services program is further operable to verify that the funds account has sufficient funds to cover payment of said further amount prior to paying said further amount, and if there are not sufficient funds, prompting the user to select a response indicative of one of the group of a (i) different amount for use as part of the further payee information, and (ii) canceling a prior payment transaction.
